(19) United States
(12) Patent Application Publication
(10) Pub. No.: US 2017/0289202 A1
(43) Pub. Date: Oct. 5, 2017

(54) INTERACTIVE ONLINE MUSIC EXPERIENCE

(71) Applicant: Microsoft Technology Licensing, LLC, Redmond, WA (US)

(72) Inventor: Georgios Krasadakis, Dublin (IE)

(21) Appl. No.: 15/087,908

(22) Filed: Mar. 31, 2016

(51) Int. Cl. H04L 29/06; H04L 29/08

(52) U.S. Cl. CPC H04L 65/1069; H04L 67/06; H04L 67/02; H04L 67/1095; H04L 65/60

(57) ABSTRACT

Disclosed herein are the mechanisms and devices for establishing interactive, synchronized private music sessions between two or more users in which the users can select and control music that is simultaneously and synchronously played on their respective devices while users interact using text, images and other communications. Music applications on the devices facilitate the establishment of the private music sessions upon user request. Songs may then be selected, either locally from the devices themselves or through online music streaming services, by one or more of the users and played on different users' devices. Additionally, songs may be recommended to the users, or just one user, based on prior music sessions and communications of the users. Songs may be manually selected by the users or recommended by an online service based on user profiles, interactions, or other indicators that signal what the users may enjoy hearing.

### BACKGROUND

The proliferation of the Internet and ubiquity of conventional smart phones, tablets, and other mobile computing devices have created an entire industry of software applications. One particular area that has been fundamentally transformed through mobile applications is the area of music. Now, users can listen to a wealth of music instantly through various streaming services on their mobile devices. Songs may be purchased and music stations may be created over a network connection, allowing users to easily access music from their favorite artists or discover new music without having to tune devices to the particular radio frequencies or purchase music on physical records, cassettes, or compact discs (CDs).

Today's music streaming applications allow users to search for specific musical artists or genres of music directly on their mobile devices. For example, a user may enter an artist's name on their smart phone, and an online music-sharing service may stream music from that artist—or related artists—to the user's phone. But a user must know what they want to hear, or at least guess the correct genre of music, and the music is streamed directly from a music service, not hand-picked by other users. While conventional music services use complex algorithms to predict the kind of music users want to hear, such algorithms only take into account the collective history of other users with similar profiles.

### SUMMARY

The disclosed examples are described in detail below with reference to the accompanying drawing figures listed below. The below Summary is provided to illustrate some examples disclosed herein. It is not meant, however, to limit all examples to any particular configuration or sequence of operations.

Some examples are directed to establishing and managing private music sessions between host and guest users. Devices of the users include music applications configured to coordinate a music-sharing experience that creates and manages private music session. Host users can search for and locate potential guest users to invite to the private music session. If the host user's invitation is accepted by the guest user, a private music session may be created and one—or both—of the users may select music to play in an interactive fashion.

The selected music is played on the devices of both the host and guest users simultaneously and synchronously, allowing the users to not only select music to share, but also enjoy listening to the same songs as their friends at the same time. Along these lines, the music-sharing service monitors the real-time playback of the songs on the respective devices to ensure the two (or more) are synchronized. If not, the music-sharing service may adjust how the music is played on one or both devices. Additionally, the users may exchange messages back and forth about their listening experience.

### BRIEF DESCRIPTION OF THE DRAWINGS

The disclosed examples are described in detail below with reference to the accompanying drawing figures listed below:

FIG. 1 illustrates a block diagram of a mobile device configured to support private music sessions

FIG. 2 illustrates a diagram of a networking environment for facilitating private music sessions between a host user and a guest user.

FIG. 3 is a sequence diagram illustrating operations for creating a private music session between a host user and a guest user.

FIGS. 4-6 are flow chart diagrams illustrating various work flows for establishing private music sessions on multiple client computing devices.

Corresponding reference characters indicate corresponding parts throughout the drawings.

### DETAILED DESCRIPTION

The various embodiments will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Examples disclosed herein generally relate to a music service that allows users to share music with each other using their respective mobile devices in private music sessions. One user (a “host user”) invites another user (a “guest user”) to participate in a private music session in which the two of them synchronously listen to music together using their respective devices at the same time. Once a private session is created between the host and guest user, either user may select locally stored songs or songs from a web-based repository or a streaming service to play on the devices during the session. Alternatively, the users may share their locally stored songs during the session by providing metadata indicating specific songs to the other party, who can in turn retrieve the shared song from an online music streaming service while the sharing user is playing the song locally. In such examples, the sharing user plays the song from a locally stored song file, and the other user streams the song from the music streaming service. Additionally or alternatively, the actual local song files of users may be shared online through a web-based file-sharing service (e.g., OneDrive™ offered by the Microsoft Corporation®), whereby a user uploads a particular song file to share to the file-sharing service, and the other user accesses or downloads the uploaded song file. Moreover, the users may also, in some examples, chat with each during the private music session.

As referenced herein, a “private music session” or simply a “private session” refers to a listening or viewing experience on two or more mobile computing devices in which a select group of users listen to music in a synchronized manner. For example, a host user and a guest user may establish a private music session in which the two of them listen to songs that are selected by one (in some examples) or either (in other examples) of the users. The session is “private” in that only invited participants may listen together. The music is played synchronously on both device and the time of play, in some examples, is tracked by a music-experience coordination service to ensure the same point of the song is being heard by the connected users. And the session is “live” in that users can select which songs to play, either from their respective local memory (downloaded songs on the guest or host user devices) or from an online streaming service.

The disclosed examples create a unique type of social interaction between the host and guest users that is driven and powered by the music itself. The two users, located in different places, establish a private music session using their mobile devices (e.g., smart phone, mobile, tablet, wearable device, laptop, gaming console, virtual reality device, or the like). In some examples, the host user sends an invitation to the guest user to the listen a particular song located either on the host user's device or in an online music-sharing service. As soon as the guest user accepts the invitation, the private music session is initiated, whereby the host user may play any song on the guest user's device (in some examples) or the guest user may play any song on the host user's device (in other examples).

During established private music sessions, songs are played on the host and guest devices in a synchronous manner. To do so, some examples use a cloud-based application to initiate songs playing on the devices, monitor their playing on the devices, and (optionally) correct the playing on one device if the two become unsynchronized. For example, the song playback on the guest device may be paused so that the host device can catch up. By synchronizing the songs playing on the devices, the guest and host users can effectively listen to music in a contemporaneous manner, providing a shared and private listening experience between the host and guest user.

Additionally, once a private music session is established between the host and guest user devices, songs may be selected by either the host or guest user to synchronously play on both devices. These songs may be stored on and accessed from the host device, the guest device, and/or one or more online music-streaming services, providing the guest and host users a large repository of music to hear during their private music session. As such, the disclosed music service acts as an aggregator on top of multiple streaming music services, offering a wider collection of music with a seamless unified experience for the user. This greatly expands the song selection of either user to include the libraries of the other user as well as the music available in different online music services.

As previously mentioned, the guest and host users may select songs stored on their client mobile devices to play during private music sessions. Alternatively, during the music session, the users may elect to have music streamed to both the host and guest devices from online music services. In this latter scenario, the streamed music may be selected either in a just-in-time (JIT) manner or queued beforehand, and in either case, the music may be synchronously played on the guest and host devices.

In some examples, the disclosed music-session service is implemented, at least partially, through a music application executing on the mobile devices of the users. The music application provides a mechanism for users to communicate messages with each other during private music sessions about the music they are hearing, or any other type of social interactions (e.g., asking each other how the day is going, discussing upcoming sports events, etc.). The users may send text messages, images, emoticons, video, animations, vibrations, haptic signals, and/or other indicators to one another that indicate their thoughts about the music. For instance, a guest user may send the host user an emoticon of a smiley face or a “thumbs up” to indicate that they like the song being played. Chat interactions may take various forms. General social interactions between the host and guest users may take place across the chat engine disclosed herein. Additionally or alternatively, the chat engine may also allow the users to interact by sending each other music-specific actions, such as reactions to the songs being played, queued, or previously heard (either in the current session or previous sessions). In sum, the chat engine disclosed herein is flexible in that it allows the users to engage each other in a generally social manner and also more specifically regarding the music being shared.

In some examples, messages about the music may be used to either select the next music to play or otherwise tag the playing music according to the user data. For example, a “thumbs down” may indicate that the song should not be played again during sessions between the two users; whereas, a text message saying “Love U2” may indicate that additional U2 songs should be played. Countless examples exist about how the user data may be used and need not be listed exhaustively herein.

Conventional music services do not allow multiple users to communicate the information back and forth to each other while music is synchronously being played on the users' devices. Doing so, as the examples disclosed herein provide, allows users to enjoy a different kind of user experience in which they can interact with friends, family, or just other users who are also listening to the same song. Also, users need not store as many songs on locally if the universe of songs expands to the devices of their friends, thereby freeing storage space.

Moreover, conventional services do not allow for communication data between the users themselves to be used in the selection of music to play, let alone to play during private music sessions of two or more users. At best, today users can comment on music being played through social networking sites, but this requires the users to navigate to and publically post comments to such sites. The examples disclosed herein provide an enhanced experience that allows users to interact with each other much faster and while listening to the same music as other users.

The private music sessions disclosed herein may be between a guest and a host user. Alternatively, private music sessions may be created between multiple users. For example, a single host user, such as a renowned artist or disc jockey (DJ), may invite a collection of guest users to join a private music session that enables the artist or DJ to select music to synchronously play on the guest users' devices. Messages about the streaming music may be gathered and provided back to the host artist or DJ as potential feedback about the songs being played, either in real time or in aggregation at later times (e.g., periodically, on demand, etc.).

In another example, a collection of users, such as those connected through a social networking site, may create a private music session in which any of the users may select songs to play—either from local or online libraries—for the entire group, or just listen to music selected through online music-sharing services. Again, the users may communicate with each other about the music, and their communication data may be used to either rate the music being played and/or select subsequent songs to be played and/or optimize the overall experience.

A user with the music application disclosed herein installed on their client device may search various online music catalogues with multiple criteria and interfaces for music to share with one or more other users. Examples disclosed herein generate just-in-time recommendations to each private-session user, taking into consideration multiple inputs, such as the continuously evolving implicit user preferences, reactions to songs being served during private music sessions, specific reactions on certain songs, comments on songs, detected emotional reactions, and the like. The system also generates and uses preference and assessment song metadata for each user segment, including patterns on trending and seasonal songs along with predictions on potentially popular songs. Thus, the system continuously learns users' preferences and music related behavioral patterns for masses of users.

Moreover, some of the examples disclosed herein refer to songs being shared in private, music sessions. Other audio besides musical songs may also be shared in the same manner. For example, voice messages, podcasts, recordings, sound bites, or any other type of audio file may be substituted throughout this disclosure in place of an actual song. Further still, alternative examples may share video files using the techniques and the components described herein. Thus, this disclosure and its referenced examples are not entirely limited to just song files.

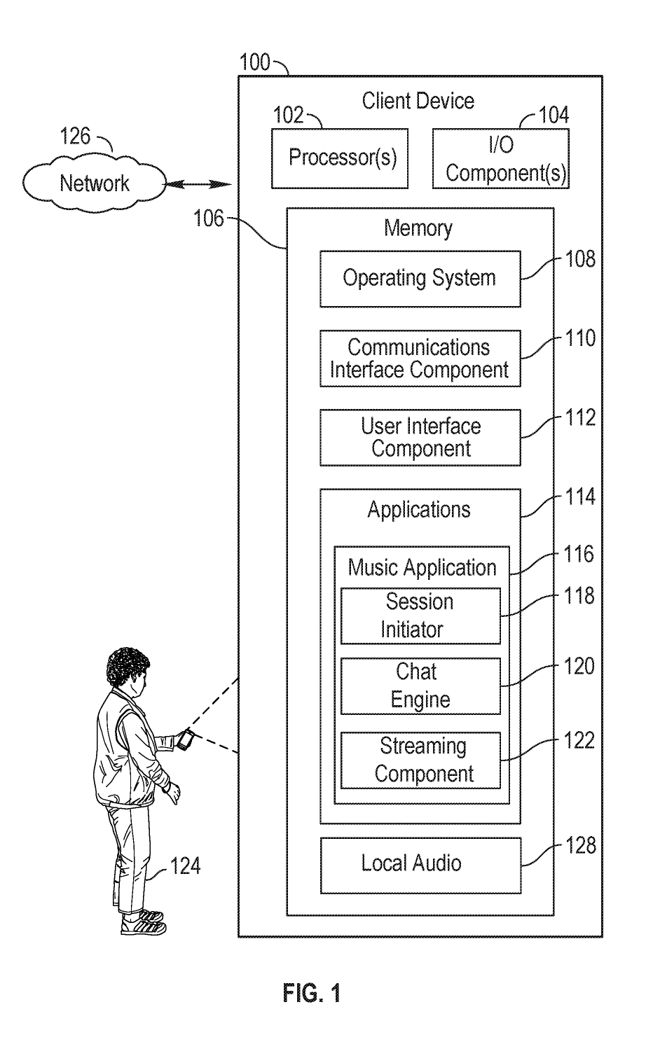

Having generally described some of the examples, attention is now drawn to the accompanying figures. Referring again to FIG. 1, an exemplary block diagram illustrates a mobile client computing device 100 configured to support private, synchronized music sessions between two or more users. The client computing device 100 represents any device executing instructions (e.g., as application programs, operating system functionality, or both) to implement the operations and functionality described herein associated with the client device 100.

The client computing device 100 may take the form of a mobile computing device or any other portable device, such as, for example but without limitation, a mobile phone (e.g., smart phone), a laptop, a tablet, a computing pad, a netbook, a gaming device, a virtual reality headset or device, a wearable device (e.g., smart glasses, fitness band, electronic watch, etc.), and/or a portable media player. The client computing device 100 may also include less portable devices such as desktop personal computers, kiosks, tabletop devices, electric automobile charging stations, electronic component of a vehicle (e.g., a vehicle computer equipped with cameras or other sensors disclosed herein), or the like. Other examples may incorporate the client computing device 100 as part of a multi-device system in which two separate physical devices share or otherwise provide access to the illustrated components of the client device 100.

In some examples, the client computing device 100 has at least one processor 102, one or more input/output (I/O) components 104, and computer-storage memory 106. More specifically, the computer-storage memory 106 is embodied with machine-executable instructions comprising an operating system 108, a communications interface component 110, a user interface component 112, various applications 114, and locally stored audio 128. In some examples, the applications 114 particularly include a music application 116 comprising a session initiator 118, a chat engine 120, and a streaming component 122.

The processor 102 may include any quantity of processing units, and is programmed to execute computer-executable instructions for implementing aspects of the disclosure. The instructions may be performed by the processor, by multiple processors within the computing device, or by a processor external to the client computing device 100. In some examples, the processor 102 is programmed to execute instructions such as those illustrated in the flowcharts discussed below and depicted in the accompanying drawings. Moreover, in some examples, the processor 108 represents an implementation of analog techniques to perform the operations described herein. For example, the operations may be performed by an analog client computing device 100 and/or a digital client computing device 100. In operation, some examples program the processor 102 to establish a private music session in which music is synchronously played on the client computing device 100 with another (host or guest) client computing device 100.

The I/O components 104 may include display, audio, haptic, and other presentation devices that visibly, audibly, or otherwise present information to a user 124. The I/O components 104 may include various presentation components and corresponding I/O ports and device drivers, including, for example but without limitation, display screens, monitors, touch screens, phone displays, tablet displays, wearable device screens, televisions, speakers, vibrating devices, tactile-morphing screens, headphones and headphone inputs, and any other devices configured to display, verbally communicate, or otherwise indicate output to a user. Additional presentation components readily apparent to one skilled in the art may also be included.

The computer-storage memory 106 includes any quantity of memory associated with or accessible by the computing device 100. Memory 106 may be internal to the client computing device 100 (as shown in FIG. 1), external to the client computing device 100 (not shown), or both (not shown). Examples of memory 106 include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other form of device memory. Memory 106 may also take the form of volatile and/or nonvolatile memory; may be removable, non-removable, or a combination thereof; and may include various hardware devices (e.g., solid-state memory, hard drives, optical-disc drives, etc.). Additionally or alternatively, memory 106 may be distributed across multiple client computing devices 100, e.g., in a virtualized environment in which instruction processing is carried out on multiple devices 100. For the purposes of this disclosure, “computer-storage memory” and “memory” do not include carrier waves or propagating signaling.

As shown in the depicted example, memory 106 stores instructions for an operating system 108, a communications interface component 110, a user interface component 112, and applications 114 that facilitate the establishment and the management of the private music sessions discussed herein. One skilled in the art will appreciate and understand that numerous over computer program modules may also be stored in memory 106.

In some examples, the communications interface component 110 includes a network interface card and/or a driver for operating the network interface card. Communication between the client computing device 100 and other devices may occur using any protocol or mechanism over a wired or wireless connection, or across a network 126. In some examples, the communications interface component 110 is operable with radio frequency (RF) and short-range communication technologies, e.g., near-field communication (NFC) tags, BLUETOOTH® brand tags, or the like. In some examples, the communications interface component 110 communicates with remote content memory of a remote device, such as a server or cloud infrastructure. The remote memory, for example, may receive, store, and send data related to content analytics, user analytics, and/or pattern data related to the private music sessions and communications between the user 124 and another user.

In some examples, the user interface component 112 includes a graphics card for displaying data to the user and receiving data from the user. The user interface component 112 may also include computer-executable instructions (e.g., a driver) for operating the graphics card to display images or audio on or through the I/O components 104.

In some examples, the music application 116 includes machine-executable instructions for establishing private music sessions with other client computing devices 100. A private music session may be initiated in a number of different ways. To initiate a private music session, a host user 124 may request one or more guest users to join the session using the music application 116. The music application 116 is configured, in some examples, to access an available network of guest users who are ready to connect in a music session at any given time. Available guest users may be found and presented to the host user 124 as potential music session participants based any number of filtering factors: social media connections, preferences in music, phone contacts, demographics, interest in listening to music, and the like.

Alternatively or additionally, the host user 124 may actively request particular guest users—or guest users may actively request particular host users—using device and user-specific identifiers, e.g., phone numbers, e-mail addresses, video chat identifiers, user profiles, public personas, or the like. For example, several guest users may seek out a specific DJ to operate as a host user 124 by typing and searching the DJ's artistic name to the see whether (s)he is available for a music session. For the sake of clarity, however, the examples disclosed herein refer to a “host” user being the user requesting a music session to be initiated and a “guest” user being a user accepting the host user's request. Numerous other examples exist for searching and finding guest and host users 124.

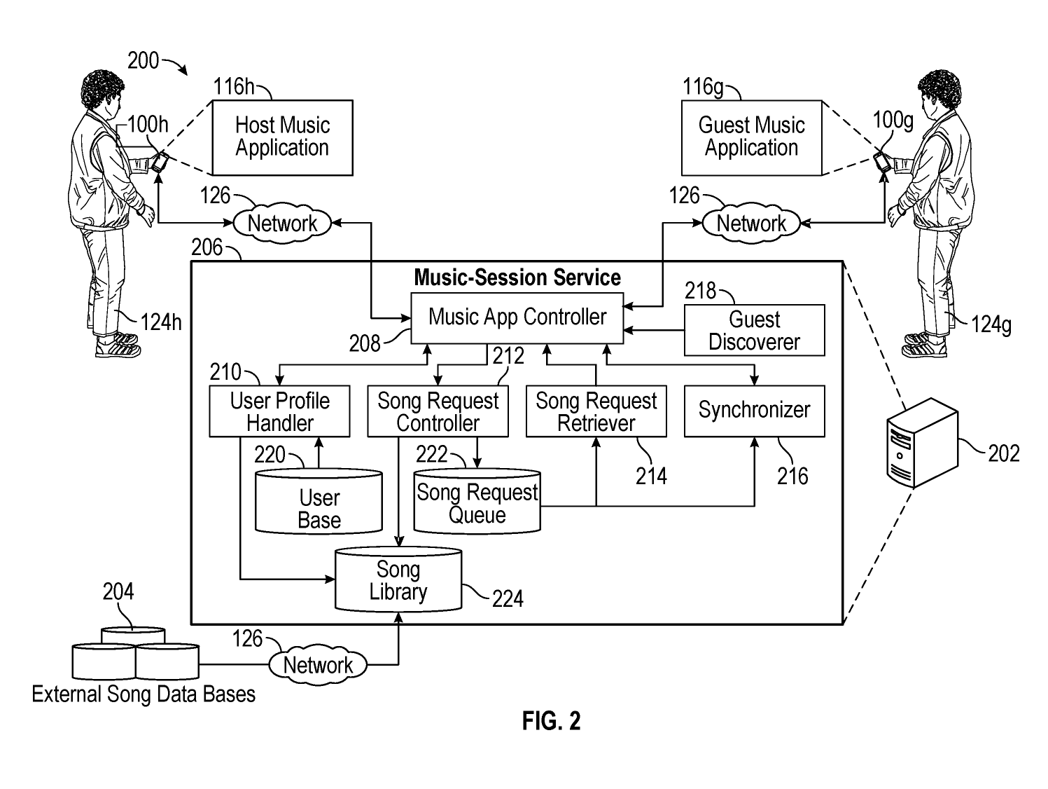

Once the requested (host or guest) user accepts the invitation to join a music session initiated by a requesting (guest or host) user, in some examples, the session initiator 118 of the music application 116 initiates the music session between the disparate client computing devices 100. Creation of the music session may be carried out by a web application, such as the music application (app) controller 208 described in more detail below in reference to FIG. 2. The music app controller 208 is also referred to herein as an “online music-sharing” service.

In some examples, the online music-sharing service may, in turn, invite the guest user to the music session, and if the guest user accepts, the online music-sharing service may then instruct the streaming components 122 of the host and guest user client computing devices 100 to begin playing the selected song. In some examples, the streaming service 122 requests songs that are queued to be shared from online music services and plays the songs for a given (host or guest) user. In some examples, the online music-sharing service also monitors playback on the host and guest user client computing devices 100 to ensure they are being played simultaneously. The online music-sharing service may signal playback speeds to change or pausing to occur when one streaming component 122 gets ahead of another when playing the selected song.

The music to be shared may include any song in the local audio 128 stored on the client computing device 100 of the host user or the guest user. Once the locally stored song is requested, the storing client computing device 100 may then provide either the song itself—e.g., via file upload/download to a file-sharing service—or metadata about the song (e.g., song title, artist, etc.) to the online music-sharing service, so that the online music-sharing service can locate the song. In some examples, the online music-sharing service may then queue the song to be played on both client computing devices 100 and monitor the playing of the song (e.g., by watching the play time) on the client computing devices 100 to ensure the songs are playing synchronously. The streaming component 122 plays the queued songs on the respective client computing device 100, and the online music-sharing service ensures that the songs are played in synchronization at the same time.

The chat engine 120 allows the host and guest users to exchange messages with each other. In some examples, the chat engine 120 sends messages as short message service (SMS) messages, multimedia messaging service (MMS) messages, voice messages, or other types of messaging. The chat engine 120 may additionally or alternatively signal messages via vibrations, sounds, virtually reality displays, tactile morphing screen, or other types of indicators. Moreover, the messages may include any number of expressions, including, for example but without limitation, emoticons, text, images, videos, animations, icons (e.g., thumbs up/thumbs down), sounds, graphics, morphing formations, or the like. In some examples, all or a selective group of the messages, events, and interactions between the users are saved as part of the private music session and history, and made accessible later on to the participants in the session. Additionally or alternatively, the disclosed examples may also use “natural language processing” to ascertain and interpret the communications between the participant users of the private music sessions, understanding particularly, in some examples, whether the communications and interactions are social in nature or related to song, artist, or genre of music being played. These more specific social interactions (e.g., those regarding the song, artist, or genre) may be used by some examples to optimize the selection of songs to suggest to users.

Additionally, in some examples, the messages shared between the guest and host users may be captured—either with or without song data indicating which song was playing during the messages—by the online music-sharing service facilitating the music session and used to learn about the specific users' reaction to the music, which may in turn be used to understand the host and guest users' interests or the interests of others. In this vein, text that is sent may particularly be mined for key words or phrases that indicate emotion (e.g., positive, negative, or indifferent) that can be associated with one or more users' reactions to the user. For example, if a U2 song is playing and the host user texts “I love this!!” to which the guest user responds “It is okay,” the online music-sharing service may interpret the use of “love” and an exclamation point in the host user's response to mean that the host user is really excited about the music. Whereas, the word “okay” in the guest user's response indicates the guest user is indifferent or not excited about the music. In other examples, the guest user may send the host user an emoticon of face pinching a nose or an animation of a bomb blowing up to indicate dislike of the song.

Patterns or assumptions derived from the messages sent back and forth between chat engines 120 of the client computing devices 100 of the guest and host users may be used by the online music-sharing service to select future music to be recommended to the guest and host users during the music session or may be used to build robust user profiles of the different users. User profiles indicating the songs users like or dislike—either separately or together—may be built or refined based on the music sessions and the messages communicated between the host and guest users. For example, users who are listening to a particular DJ may send messages during a particular DJ set that may be aggregated and accessed by the DJ to determine how various songs, transitions, or other portions of the set were received. In other examples, guest users who are listening to live stream of a rock concert through their client computing devices 100 at different locations may message each other and provide feedback that is useful to the rock band, such as which songs were popular, whether messaging tailored off for a particular slow song that followed a faster song (perhaps indicating the change in tempo was too extreme), or which song was the most popular (perhaps indicating a decent candidate for band's next single to be released). These examples are not exhaustive by any manner, and instead are provided as just a few examples of how feedback messaging may be used by the disclosed examples.

FIG. 2 illustrates a diagram of a networking environment 200 for facilitating private music sessions between a host user 124h and a guest user 124g. The host user 124h is operating a host device 100h, and the guest user 100g is operating a guest device 100h. Host device 100h and the guest device 100g may take the form of client computing device 100 discussed above in reference to FIG. 1. The two client computing devices 100h,g communicate over the network 126 with an application server 202 that provides a music-session service 206. Networking environment 200 also involves a database cluster 204 that services as a repository for music, shown as the external song databases 204.

Networking environment 200 is merely an example of one suitable computing system environment and is not intended to suggest any limitation as to the scope of use or functionality of examples disclosed herein. Neither should the illustrated networking environment 200 be interpreted as having any dependency or requirement related to any single component, module, index, or combination thereof. Also, the depicted devices themselves may in actuality include multiple devices. For example, the application server 202 may be hosted on a collection of remote servers, or across one or more virtual machines (VMs). Moreover, the external song database cluster 204 is shown as collection of data storage devices; yet, some examples may use only a single sever to store songs that are for users. The external song database may take the form of one or more music-streaming services (e.g., Microsoft Groove™, Spotify®, Pandora®, etc.). The music-streaming services may extend access to their music catalogs and search features through an API, allowing private music session users who have registered accounts with the services to access and share a plethora of music. Thus, the servers of 202 and 204 may encapsulate different quantities of physical devices than those shown.

The network 126 may include any computer network, for example the Internet, a private network, local area network (LAN), wide area network (WAN), or the like. The network 126 may include various network interfaces, adapters, modems, and other networking devices for communicatively connecting the client computing devices 100, the application server 202, and the external song database cluster 204. The network 126 may also include configurations for point-to-point connections. For the sake of simplicity, network environment 200 shows what appears to be three separate instances of the network 126, but in actuality, the network 126, in some examples, represents a single public, private, or hybrid network. Computer networks are well known to one skilled in the art, and therefore need not be discussed at length herein.

The client computing devices 100h,g may be equipped with the music application 116 described above in reference to FIG. 1, To simplify the rest of this disclosure, the respective music applications are labeled as the host music application 116h on the host computing device 100h and the guest music application 116g on the guest client computing device 100g.

The application server 202 represents a server or collection of servers configured to execute the music-session service 206 in order to provide the host user 124h and the guest user 124g with a platform for connecting in private music sessions. Specifically, the music-session service 206 on the application server 202 includes memory with executable instructions comprising a music application app controller 208, a user profile handler 210, a song request controller 214, a synchronizer 216, a guest discover 218, a user base database 220, a song request queue database 222, and a song library database 224. The illustrated instructions may not all be hosted by the application server 202. Rather, some examples may include any of the depicted instructions of the music-session service 206 on remote devices or as part of other online music-sharing services. For instance, the guest discoverer 218, which as is explained below, provides the host user 124h access to the potential guest users 124g the host user 124h, may be provided from another online music-sharing service, such as, for example, but without limitation, a social networking site that offers users' online availability via an application programming interface (API).

In operation, the host user 124h accesses a front-end user interface (UI) of the host music application 116h for the music-session service on the client computing device 100h. In some examples, this music-session UI provides the host user 124h with an option to discover available potential guest users 124g who are available at that moment in time. Alternatively, some examples allow the guest users 124g to broadcast their availability, as determined by digital calendars, movement of the client computing device 100g (e.g., if the device is traveling above a specific speed limit, the potential guest user 124g may be deemed unavailable), data or Internet connection (e.g., existence, quality, or type), or the like. Alternative still, the guest user 124g may select an option on a front-end UI of the guest music application 116g that indicates his/her availability. Various different techniques may be used to gather the current or future availability of guest users 124. Such availability information, in some examples, is gathered by the guest discoverer 218 and provided to the host user 124h via the host music application 116h. Additionally or alternatively, a user may also access a set of other users with whom they had previous private music sessions.

The host user 124h may search for particular guest users 124 in any number of ways to retrieve their availability. Contacts on the client computing device 100h may be accessed by the host user 124h, and availability gathered for the individual users either upon request of the host user 124 or for all contacts. Alternatively, available guest users 124g may be suggested to the host user 124h based on social media profiles, previous electronic mail (e-mail) or text message communications, phone calls, or the like. Moreover, some examples may not suggest available guest users 124g at all to the host user 124h.

The host user 124h may invite the guest user 124g to participate in a private music session by submitting a music-session request using the session initiator 118 of the host music application 116h. The session initiator 118 sends the music-session request over the network 126 to the music-session service 206, which receives and provides it to the music app controller 208.

The music app controller 208 may be implemented in software, hardware, firmware, or a combination thereof. In some examples, the music-app controller 208 includes an API to execute instructions performing the various operations described herein. The music-session request may include any number of identifiers and metadata specific to the guest user 124g or to all users (e.g., the one sending the invitation and the one(s) receiving the invitation). Examples of such identifiers include, without limitation, a phone number, an e-mail address, a device identifier (e.g., media access control or “MAC” address), a user profile, a social networking profile, a name, or other digital identifier and metadata associated with the guest user 124g or the host user 124h. Using the user identifiers, in some examples, the user profile handler 210 retrieves the identification of the guest user 124g or the host user 124h from the user base database 220 as well as contact information. The music app controller 208 may then submit an invitation to join the private music session to the client computing device 100g of the guest user 124g, which the guest user 124g may accept or reject. If the guest user 124g accepts the invitation, the private music session is established, and the two users 124 can start interacting by selecting songs to be played and interacting with each other with comments or other indicators (e.g., emoticons, animations, video, images, voice etc.). If rejected, in some examples, the host user 124h may be notified of the rejection.

The private music session, once established, allows songs to be synchronously played on the client computing devices 100h,g at the same time. In some examples, once a song is selected by a user 124 (the “selecting user”), either from the selecting user 124's local audio 128 or from an online source, such as the song library 224, accessible through the song request controller 212, or from an integrated online streaming service (e.g., Microsoft Groove™).

In some examples, when the selecting user 124 submits a song from their local audio 128, either the song file may be transmitted to the music app controller 208 or song identifiers may be transmitted to identify the song in the song library 224. The song identifiers may include a title, artist, version, album, file name, platform, combination thereof, or other identifying attribute of the song. In some examples, if the user submits a song file of a song that is not currently in the song library 224, the song library 224 may add the song file for later use.

Alternatively, songs may be selected for the users from the song library 224 based on historical data of the users 124h,g or a group of other determined to have similar preferences. The users 124h,g may select a particular genre of music, artist, album, or other grouping of music, causing the music app controller 208 to access the song request controller 212 to retrieve songs related to the selection criteria. For example, the guest user 124g may elect to listen to songs from The Beatles from the band's White Album, thereby prompting the song request controller 212 to select songs to play from that album—either randomly or based on prior interactions.

Additionally or alternatively, a user 124 may also browse the available songs for play in the song library 224. The external song databases 204 may provide songs to the song library 224 from one or more music streaming services. Some of the services may require customers streaming songs to be registered with the service, and in some examples, the selecting user 124 may additionally submit appropriate credentials to play particular songs that are available in the song library 224.

In some examples, the song request controller 212 identifies the songs to be played during the music session and queues the songs for play in the song request queue 222. The song request retriever 214 retrieves songs from the song request queue 222 and provides the retrieved songs to the music app controller 208. In some examples, the music app controller 208 checks the status of the song request queue 222, and then supplies song-specific information about the queued songs (e.g., song title, artwork, artist, genre, release date, hyperlinks to web pages with additional information, etc.) to the client computing devices 100h,g. In some examples, the music app controller 208 streams the songs that are queued to the client computing devices 100h,g according to the queued order.

Alternatively, the song request controller 212 queues song titles, uniform resource identifiers (URIs), or other identifiers to be played, and communicates through the music app controller 208 with the host music application 116h and the guest music application 116g to instruct both to respectively stream the queued songs from respectively accessed music services. For example, the song request controller 212 may queue Song_A to be played, and use the music app controller 208 to direct the host music application 116h to stream the song from music service ABC and the guest music application 116g to stream the song from music service XYZ.

The client computing devices 100h,g receive and respectively present the song-specific information to the host user 124h and the guest user 124g. As the songs play, the music app controller 208 individually monitors the time of play for each instance of the song being played on the client computing devices 100h,g, checking to determine whether the songs are in synchronization with each during playback. If so, the music app controller 208 lets the songs continue to play. If not, the music app controller may, in some examples, use the synchronizer 216 to synchronize the songs on the devices 100h,g. In some examples, the synchronizer subtly (i.e., without perception to the human ear) speed up or slow down the playing of the song on one client computing device 100 to synchronize with the playing of the song on the other. Alternatively or additionally, the synchronizer 216 may pause play of the song on one client computing device 100 so that the other can catch up.

As songs play, the users 100h,g may exchange messages back and forth using the chat engine 120 described above in reference to FIG. 1. In some examples, such feedback information is captured by the music app controller 208 and provided to the user profile handler 210 for storage in the user base database 220. Feedback comments, or inferences drawn therefrom (e.g., user mood, likability of song, etc.), may be stored by the user profile handler 210 in the user base database 220 in association with the user 124 who made the comment, the private music session, or both. Additionally, in the case when multiple users 124 are providing feedback to a single or smaller subset of host users 124h, comments may be either directly provided to the host user(s) 124h or aggregated and then provided. This helps the host user(s) 124h gather real-time feedback data that may influence what is played next.

Additionally, examples disclosed herein may also store entire sessions of music played between the host user 124h and the guest user 124g. If a particular session was inferred to enjoyable to the user 124, either the entire or a portion of the sequence of songs may be stored for playback in the sequence at a later data. This enhances the user experience by providing multiple users with not just a single song selection, but also a collection of songs that have already proven to be enjoyable. For example, a married couple may have listened to a particular set of songs that reminded them of a special event in their lives on a particular day of the year. This sequence of songs and any interactions that happened during the session may then be stored and recalled for play if the two establish a private music session on the special day in the future.

The guest user may want to impress the host user and help him/her discover songs. To this end, the music app controller 208 intelligently compiles a list of songs based on the user profiles of the guest and host user 124h in the user base database 220, taking into account the style and preferences of both users 124g,h. This compiled list of songs may be served to the host user 124h, enabling him/her to quickly make song selections and compile a queue for the particular session. Such examples provide a recommendation engine that combines the implicit preferences from both users, while optimizing the songs selected for the list to what the guest user 124g wants to hear—because the host user 124h equally wants to play songs the guest user 124g likes. These suggested songs in the list may be selected by the music app controller 208 based on the interactions of the users; songs played in prior sessions; likes/dislikes of the users; song, artist, or genre preferences; or any other disclosed parameter of the users or the user interactions.

Some examples provide an alternative, music-driven communication experience in which the users 124 may want to help each other discover songs. The song request controller 212 may be additionally or alternatively configured to compile a list of songs fitting a particular style or preferences of both users. Such a compilation may be based on metadata, inferences, music preferences (e.g., genre, time of day, frequency, etc.), or user interactions (e.g., messages) about or between either of the users and/or the songs they have previously heard. For example, if the host user 124h repeatedly listens to specific genre of music during a particular time of day, metadata may be tagged to a corresponding user profile of the host user 124h, and that metadata may be used to select songs in the particular genre during private music sessions at those specific times of day.

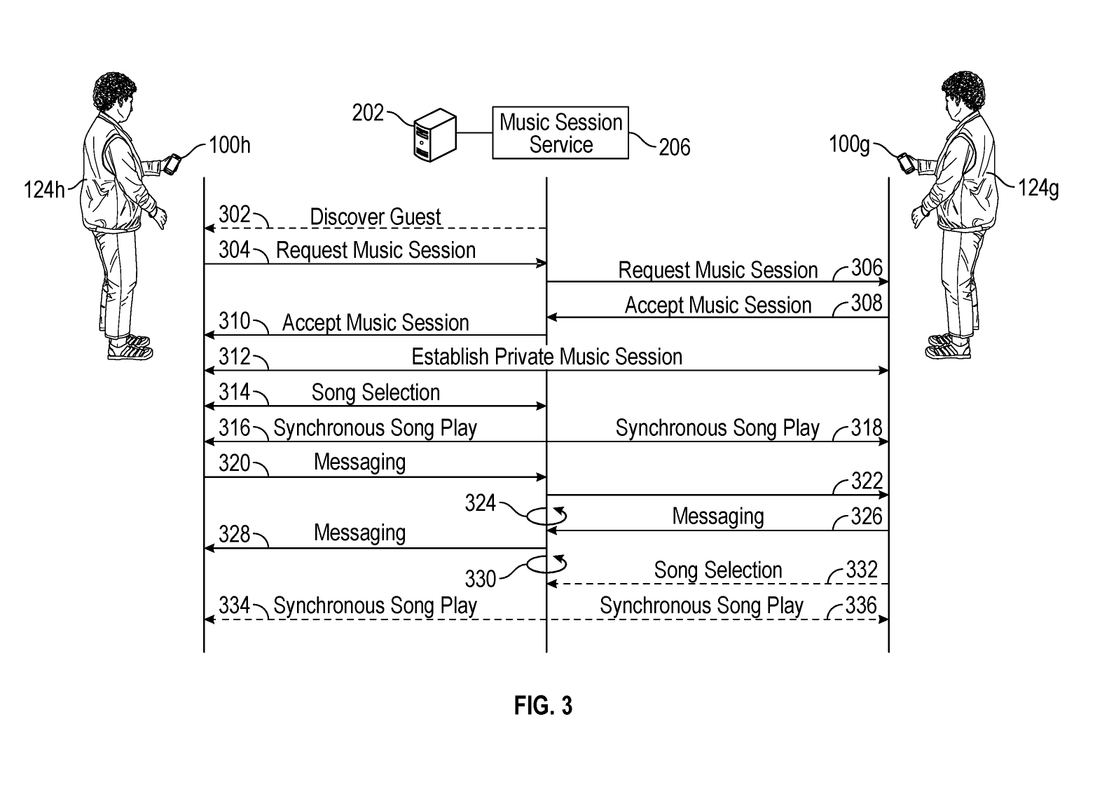

FIG. 3 is a sequence diagram illustrating operations for creating a private music session between a host user 124h and a guest user 126g. The operations are shown as being performed by the client computing device 100h of the host user 124h, the music-session service 206 of the application server 202, and the client computing device 100g of the guest user 124g. The depicted operations are but one sequence of operations for establishing and controlling the private music sessions disclosed herein, and are not meant to limit all examples. The operations may be performed out the illustrated sequence, or additional and alternative operations may also be performed.

Looking at the depicted example, the music-session service 206 initially discovers available guest users 124g, as shown at 302. Guest users 124g may be discovered in any of the ways previously discussed above, such as by way of the guest discoverer 218. Moreover, as indicated by the dotted line of operation 302, this discovery feature is optional in some examples or may be performed on a periodic basis by the music-session service 206. If performed, however, the discovered potentially available guest users are transmitted to the client computing device 100h for presentation to the host user 124h. The host user 124 may then select one or more guest users 124g to participate in a private music session. Alternatively or additionally, the host user 124h may choose a guest user 124g from a list of device, social media, or other available contacts, or the host user 124h may otherwise locate an address (e.g., e-mail, chat, etc.), number (e.g., phone, MAC, etc.), or other identifier of the guest user 124g the host user 124h wants to connect with.

The host user 124h selects a guest user 124g to connect with and initiates a music-session request to establish a private music session, as shown at 304. The transmitted music-session request—or an indication thereof—may then be provided to the guest client computing device 100g by the music-session service 206, as shown at 306. Receipt of the music-session request by the client computing device 100g causes the guest music application 116g to notify the guest user 124g that the host user 124h wants him or her to join a private music session. If the guest user 124g accepts the invitation, the client computing device 100g transmits an acceptance of the music-sharing request back to the music sharing service 206, as shown at 308. The music sharing service 206 may then notify the host user 124h of the guest user's acceptance, as shown at 310. And the music-session service 206 establishes a private music session between host user 124h and the guest user 124g, as shown at 312.

Once the private music session is established, either user 124 (guest or host) may select songs to play. For the sake of clarity, FIG. 3 illustrates the host user 124h selecting songs—either from his or local audio 128 or from the song library 224 of the online music-streaming services—to play during the private music session, as shown at 314. Continuing with the depicted example, when the host user 124h selects a song to play, and indication of that song (e.g., song name, file name, or other identifier) is communicated to the application server 202, and the music-session service 206 queues the song to be played on both devices, as shown at 316 and 318, and provides the host user 124h the ability to control playback of the selected song. For example, once the selected song begins playing, the host user 124h may pause, rewind, fast forward, replay, speed up, slow down, or otherwise manipulate the playing of the song. Similar control over song playback controls may be given to the guest user 124g as well. The music-session service 206 synchronizes the playing changes on both devices, e.g., when the host user 124h pauses the song the client computing device 100h, the music-session service 206 pauses the song on the guest client computing device 100g.

As previously mentioned, the users 124h,g may also send feedback interactions and messages to each other during the private music session, as shown at 320-322 and 326-328. The users 124h,g may comment on the music playing and also share general social interactions via text messages, emoticons, video, animations, images, or any of the previously disclosed messages. The comments may also be captured, stored, and used to infer user sentiment about the music being played, as shown by processing operations 324 and 330. For example, a user saying “I love this song” may trigger the music-sharing service 206—in particular, the user profile handler 210—to determine that the user has a positive reaction to the song, which may be usable in later automatic-song selection scenarios in which the music-session service 206 is automatically queuing songs to be played in private music sessions. The various types of feedback that may be captured and the resultant inferences that may be drawn are far too numerous to list exhaustively herein. The various examples disclosed herein may interpret such messaging in ways to select songs to be played in private music sessions—for instance, when song selection is requested by the users 124g,h—or to build more robust user profiles that indicate the specific songs, musical genres, or other characteristics of the music the host user 124h and guest user 124g like or dislike.

Additionally or alternative, the feedback messages and interactions may be captured and stored by the music-session service 206, as shown by processing steps 324 and 330. In this vein, the music-session service 206 may learn the users' 124 reactions, preferences, and likes/dislikes to the songs being played.

The feedback messages and interactions may also be aggregated from a song or an artist's perspective. Along these lines, the music app controller 208 may include instructions for interpreting reactions and emotional states from the messages and interactions, and these interpreted reactions and emotional states may be used by the music app controller 208 to derive patterns regarding the emotional states and the reactions of users to particular songs or portions of songs. These patterns may be particularly useful to the artists themselves to help understand how their music is resonating with fans. For example, an artist may use the patterned data to identify the songs they release with the strongest positive, negative, and indifferent reactions from users.

Moreover, these derived patterns may also be used in the optimization and personalization of future music sessions. For instance, users who experience positive emotions (as derived from chat responses) during certain songs may be suggested other songs that have elicited similar reactions in other users, or that have previously elicited similar responses from the users themselves.

As optionally shown in dotted lines for operations 332-336, the guest user 124g may also select songs to play during the private music session. The guest user 124g's selected songs may be queued and played by the music-session service 206 simultaneously on the client computing device 100h,g in the same manner as the songs selected by the host user 124h.

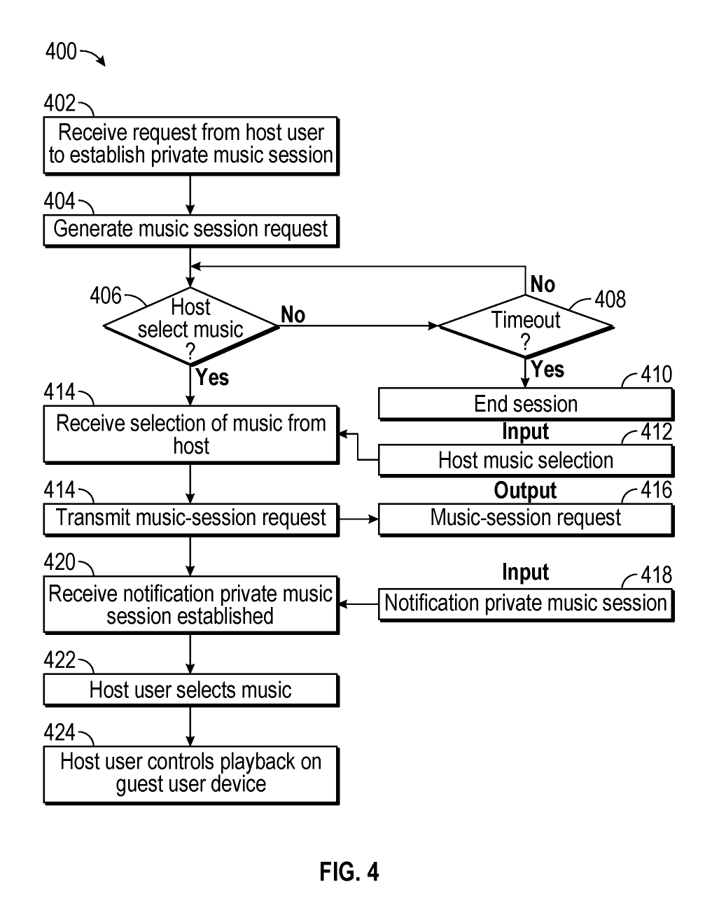

FIG. 4 is a flow chart diagram illustrating a workflow 400 for establishing a private music session on multiple client computing devices. Work flow 400 is but one depicted example and is not meant to limit all examples to any particular operations or operational sequences. Initially, a host user identifies on a host music application one or more guest users available for a private music session, using any of the aforementioned methods of guest user discovery. Once guest user(s) are selected, the host user may request that a private music be established, as shown at 402. This host user selection causes the client computing device of the host user to generate a music-session request, as shown at 404, and transmit the music-session request over a network (e.g., the Internet) to a music-sharing service, as shown at 406 and output 408. The music session request could be based on pre-defined templates and/or customized text, styling, graphics, look, feel, etc. The user could select a template and type a custom message to be sent to the users being invited.

In some examples, the music session request is timed. A host user may invite a guest user to play music for the next 20 minutes. The users may extend the twenty-minute timeframe through various interactions (e.g., selection of a particular option, automatically upon sending of a message, selection of a new song, etc.). But if the timeframe runs out, some examples will automatically cancel the private session.

The music-sharing service may then contact the guest user's client computing device and invite him or her to join the private music session. If the invitation is accepted, in some examples, the private music session is established between the client computing devices of the guest and host user, and a notification that the private music session (shown as input 414) was established is sent back to the host computing device, as shown at 412—e.g., through a templated answer or custom message.

Once a private music session is established, the host music application may wait for the host user to select music to play on the two client computing devices, both synchronously and simultaneously, as shown at decision box 414. As shown by the No path from decision box 414, the host music application waits a particular timeout period (e.g., longer than a certain period of time, such as ten seconds, one minute, etc.) for the host user to select music, as shown at decision box 416. As shown from the No path from decision box 416, the host music application waits the allotted timeout period for a song selection, and if the timeout period expires (indicated by the “Yes” path), the user session of the host music application may end, as shown at 418. If the host use makes a selection of music, as shown by the Yes paths from boxes 416 and then 414, the host user music application receives the host user's music selection (e.g., song selection), as shown at 420. In some examples, an indication (e.g., artist, logo, album, band, purchase information, etc.) of the music selected by the host user is then communicated to the music-sharing service, which in turn notifies the guest user of the selection, retrieves selected song from a web-based music library, and queues the song to be played on the guest and host users' devices simultaneously and synchronously.

Once a song is queued for playing, the host user may then control playback of the song on both the host and guest users' devices. For example, Song_A may be selected by the user to be played and consequently queued by the music-sharing service for being played on both the host and guest client computing devices. The host user may then press a play button on his/her client computing device that causes Song_A to play on both devices. The music-sharing service may also monitor the time of play on both devices to ensure that the song is played synchronously on both devices. If not, playing of the song may be paused, sped up, slowed down, or otherwise manipulated to bring the playback on the devices back into synchronization.

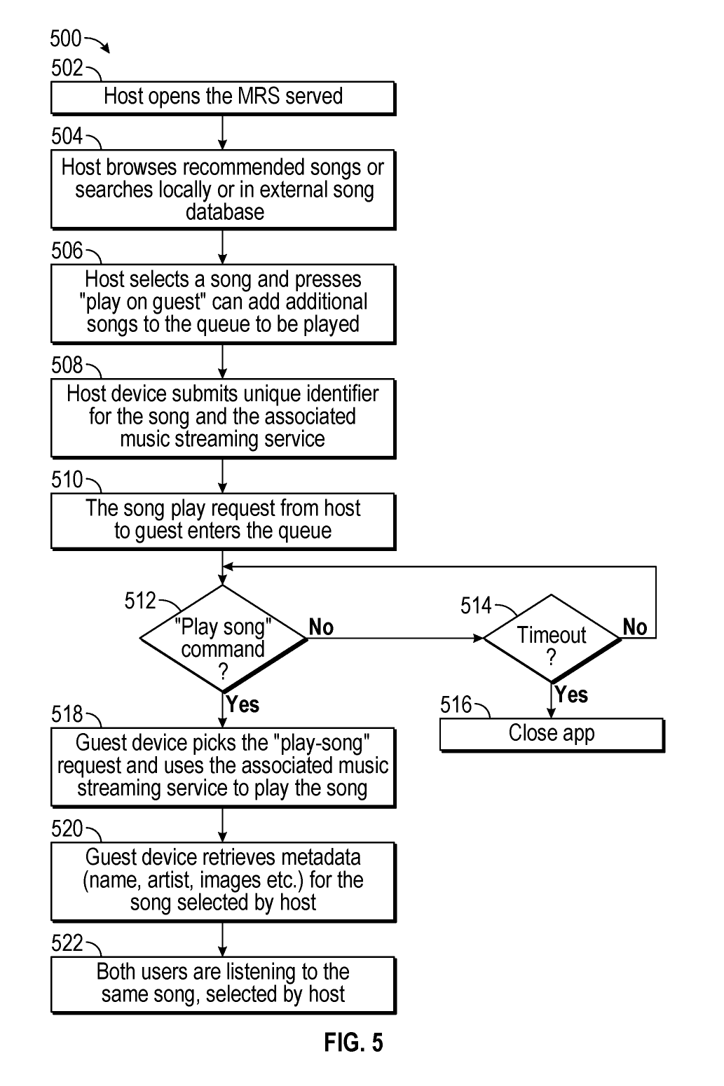

FIG. 5 is a flow chart diagram illustrating a work flow 500 for establishing a private music session on multiple client computing devices. Work flow 500 is but one depicted example and is not meant to limit all examples to any particular operations or operational sequences. As shown in block 502 of the depicted example, a host user opens a host music application on a client computing device. This host music application provides the host user, in some examples, with the ability to discover available guest users or to select potential guest users from one or more contact lists. Once the guest user accepts the invitation to join the music session, a private music session is established between the host user and the guest user.

As shown at 504, the host user browses songs locally (e.g., in local audio 128) or in a web-based song library (e.g., song library 224). Once a song is selected by the host user, the host user may select an option to “Play on the Guest User's Device,” to initiate playing of the song on the devices of the guest and host users at the same time and in synchronization, as shown at 506. Additionally, as also mentioned in 506, the guest user may add songs to the queue to be synchronously played on the devices as well.

Unique identifiers of the selected songs are sent to the song to the music-session service 206. The music-session service 206 uses the unique identifiers to find the song in the song library 224, as indicated at 508. The music app controller 208 of the music-session service 206 places the requested songs—retrieved from the song library 224—in the song request queue 222, as shown in 510.

The music-sharing service 206, in some examples, waits for the host user to begin playing the queued songs, as shown at decision box 512. In some examples, the user may first view all the queued songs that have been selected for play by the host user (in some examples) and/or the guest user or music-session service 206 (in other examples). A timeout period may be counted, as shown at decision box 514, during which the music-session session 206 may keep the songs queued. When the period times out, the private music session may be closed, as shown at 516. So long as time remains, music-session service 206 waits for the host user to play the queued songs.

When the host user presses play on a queued song, the song is played on the devices of both the host user and the guest user at the same time, as shown at 518. In some examples, when the host user presses play on a queued song, the song is streamed to be played on both the client computing devices of the host and the guest user at the same time. In other examples, an identifier of the song that the user elected to play is sent to the client computing devices of the guest user and the host user, and each device separately retrieves the song from the corresponding song library 224 comprising the libraries of the online music-streaming service(s). Additionally, the client computing device of the guest user may also retrieve specific metadata of the song being played, including, for example but without limitation, the name, artist, images, or other information about the song itself that can be displayed while the song is playing, as shown at block 520. In some examples, the host user already has this metadata information at the time of song selection, and the metadata can be stored locally and presented to the host user while the song is playing. In the end, the song is played on both client computing devices at the same time, as shown at block 522.

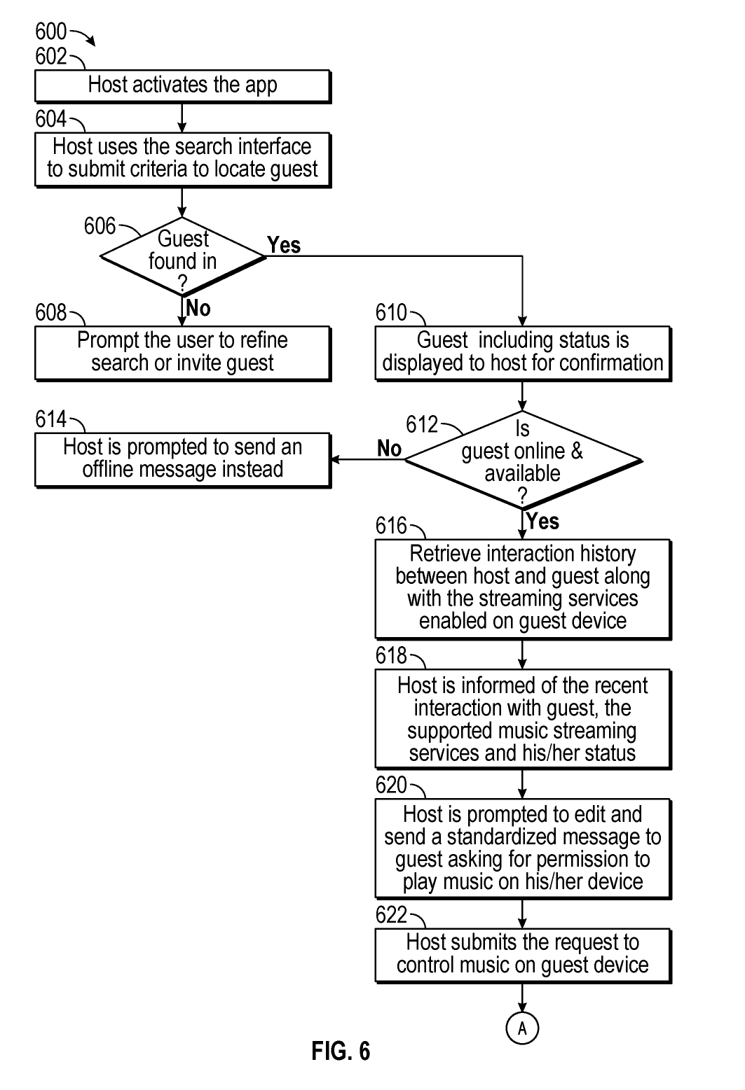

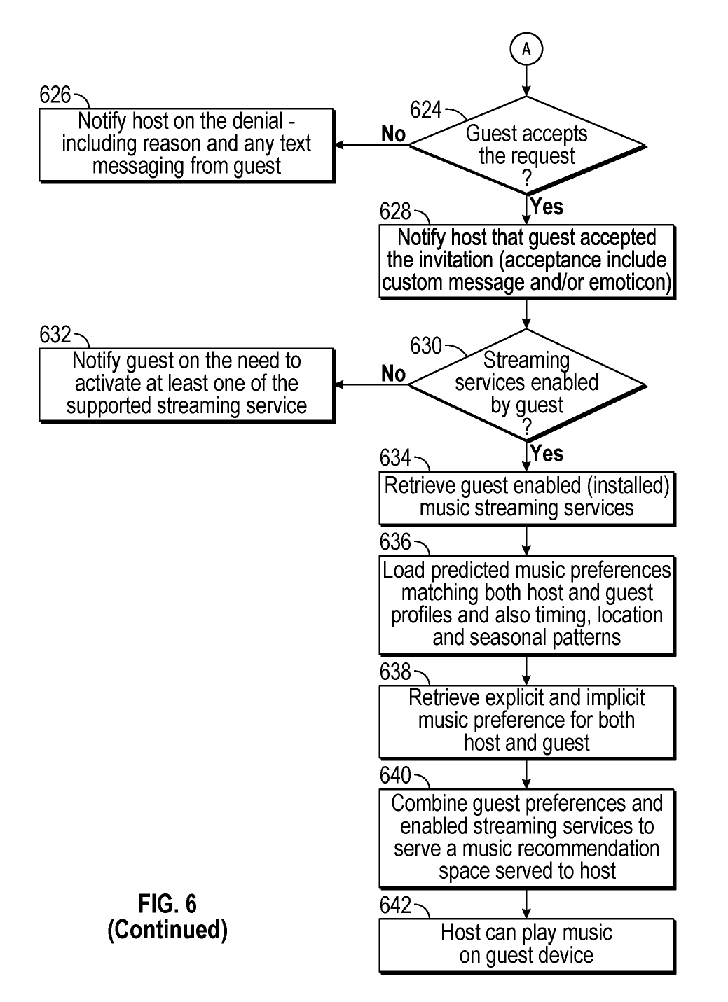

FIG. 6 is a flow chart diagram illustrating a work flow 600 for establishing a private music session on multiple client computing devices. Work flow 600 is but one depicted example and is not meant to limit all examples to any particular operations or operational sequences. As shown in block 602 of the depicted example, a host user activates a host music application. A search interface on the activated host music application is used by the host user to locate a guest user, as shown at 604. As shown at decision box 606, if no user is selected by the user, the host music application prompts the host user to refine search criteria in the search interface or directly invite the guest user (e.g., using an e-mail address, phone number, text message link, etc.), as shown at 608. Regardless of how the guest user is located, the guest user's name and status are displayed to the host user to confirm whether the host user wants to establish a private music session with the guest user, as shown at 610.

Additionally, as shown at decision box 612, the guest user's online availability is determined by the music-session service 206 and provided to the host user. If the guest user is not online, the host user is prompted to send an offline message (e.g., text message, e-mail, etc.) to see whether the guest user will accept the private music session or will connect to a network. If, however, the guest user is online, the interaction history—which may include previously played songs in private music sessions; feedback text, video, or animation messages between users; indications of interest (e.g., thumbs up/down, etc.) for the songs; song skipping; or any other guest or host user interaction with the song either during a private music session or when the guest or host user is listening to the song alone—along with the available music-streaming services that are available to the guest user are retrieved, as shown at 616. These available streaming services may include the various services to which the guest user subscribes or otherwise has an active membership. The various streaming services available to the guest host may be stored by the user profile handler 210 as part of the guest user's profile in the user base database 220.

As shown at 618, the host user is informed of any recent (e.g., previous one, two, five, etc.) interactions with the guest user, the supported streaming music services available to the guest user, and the guest user's online status. In this information, the recent interactions between the host and guest users may include a list of the previously played songs as well as some or all of the previously sent messages between the two users.

As shown at 620, the host user is prompted with a standardized and editable invitation message asking the guest user for permission to play music on the guest user's client computing device. The host user may then send the invitation to the guest user requesting that he or she allow the host user to control music on the guest user's device, as shown at 622. Continuing onto the continued version of FIG. 6, i.e., following path A, the guest user may accept or reject this invitation, as shown at decision box 624. If rejected, the host user may be notified of the guest user's denial and (optionally) the reasons for the rejection in a text message, as shown at 626. If accepted, the host user may be notified of the acceptance with an acceptance message that includes some custom saying and possibly an emoticon or other image, as shown at 628.

Upon establishment of a private music session, the guest user may be checked, by a host music application on the guest user's client computing device or remotely by the music-session service, to determine whether the streaming appropriate streaming services are enabled, as shown at decision box 630. If not, the guest user may be prompted to activate at least one supported streaming service in order to provide a gateway for selected music to be played, as shown at 632. If so, the guest user's enabled and installed music streaming services are retrieved by the host music application on the guest client computing device and reported to the music-session service, as shown at 634.

Music preferences for the host and guest user profiles are loaded, as shown at 636. These preferences may take into account listening histories of the user separately or together in a previous private music session, listening times (e.g. morning, after 5:00 pm, weekends, etc.), seasonal music preferences, listening patterns based on user locations (e.g., at the gym, at work, at an event, etc.), and any other parameters or listening patterns.

Additionally, the music-session service may also retrieve explicit and implicit music preferences for both the guest and host users from the user base database, as shown at 638. Explicitly preferences may be signaled through “like” and “dislike,” or “thumbs up” and “thumbs down”, types of indicators. Whereas, implicit music preferences may be implied through phonetic learning from user text messages, image or emoticon analysis, or other inferences gathered from other users' same messages. For example, if other users send a happy emoticon, a heart image, or specific positive text while a particular song is playing, this may be interpreted to be a positive indication, and the guest or host user's sending of this emoticon or image may be interpreted as a positive indication for a song.

Based on the users' preferences, the music-sharing service may generate a list of recommended songs that take into account the explicit and implicit inferences about music that are gathered from prior private music sessions between the users, interactions in other users' private music sessions, listening history of the users, or any other previously disclosed listening parameter. This is shown in 640. From this generated list, songs may be streamed through the available streaming services to the guest and host users just like the songs that are chosen by the host user. Playback of these automatically recommended songs may also be controlled by the host user, the guest user, or both. For example, a recommended song may be streamed simultaneously on the host and guest users' devices, and the host user may pause, fast forward, rewind, or otherwise control the playing of the song on both devices. This allows the host user to play music on the guest user's device, as shown at 642.

In some examples, the music app controller 208 understands a guest user's implicit/explicit preferences via history, reactions, interactions, etc. The music-session service may then build a “music selection set” that includes songs unknown to the guest user but with a high probability that the user may like the songs. This music selection set may be exposed to the host user only (in some examples), allowing the host user see the guest user's recommendations and selectively play songs from the music selection set. This makes the interaction fun and allows the host user to impress the other party. Thus, in contrast with conventional music-streaming services, the disclosed examples recommend to the host user what the guest user may like.

### Additional Examples

Some examples are directed to a host client computing device operated by a host user for entering a private music session with a guest user and playing music on a guest client computing device. The host client computing device includes memory for storing a host music application configured to identify the guest user and request establishment of the private music session with the guest user. One or more processors are programmed for: receiving a request from the host user to establish the private music session with the guest user, transmitting a music-session request to establish the private music session, wherein the music-session request designates a guest user, receiving notification that the private music session is established with the guest user, receiving a selection of music from the host user to play on the client computing device of the guest user, transmitting an identifier of the selection of music, receiving an instruction from the host user to play the selection of music, and transmitting the instruction to control playback of the selection of music on the guest client computing music, and also accept and manage interrupt requests from the users (e.g., pause, skip, etc.). Moreover, the selection of music is played locally and on the guest computing device at the same time.

Some examples are directed establishing a private music session between at least two client computing devices. The private music session is established through: receiving a request from a host user operating a host client computing device to establish the private music session with a guest user operating a guest client computing device; receiving an identifier of a song selected by the host user or the guest user to be played at the same time on the host client computing device and the guest client computing device; receiving a play indication from the host client computing device or the client computing device; synchronizing simultaneous playback of the song on both the host client computing device and the guest client computing device; and monitoring times of play to ensure the song is synchronously played on the host client computing device and the guest client computing device.

Some examples are directed to computer-storage media (i.e., memory) embodied with machine-executable instructions for establishing a private music session between at least two client computing devices. The private music session is established through: receiving direction from a host user operating a host client computing device to invite a guest user operating a guest client computing device to join the private music session; retrieving interaction history between the host user and the guest user, the interaction history comprising a set of previously heard songs in a prior private music session and feedback messages between the host user and the guest user during the prior private music session; selecting, based on the interaction history, at least one song to play in a private music session between the host user and the guest user; and instructing the host client computing device and the guest client computing device to play the at least one selected song at the same time.

Alternatively or in addition to the other examples described herein, some examples include any combination of the following:
memory, associated with the guest client computing device, for storing a guest music application configured to receive the transmitted instructions to control playback of the selection;
a processor associated with the guest computing device, the second set of one or more processors configured for modifying playback of the selection of music on the guest computing device;
modification of the playback of the selection of music on the guest computing device comprises at least one member of a group comprising pausing, skipping, fast forwarding, rewinding, or replaying a portion of the selection of music;
an identifier of the selection of music that comprises at least one of an indication of a song, an artist, or an audio file;
the identifier of the selection of music that comprises an audio file comprising the selection of music;
playing of the selection of music locally involves streaming the selection of music from a web-based music service;
a processor programmed for playing the selection of music locally in synchronization with the music being played on the guest computing device;
a processor programmed for receiving guest playback instructions of the guest computing device, and modifying said local playing of the selection of music based on the guest playback instructions;
a processor programmed for receiving feedback input from the host user regarding the selection of music being played, generating one or more feedback messages to send to the guest user based on the feedback input, and transmitting the one or more feedback messages for presentation to the guest user;
feedback messages comprise at least one member of a group comprising: a text message, an animation, a thumbs up indication, a thumbs down indication, or a video or voice or gestures.
identifying that playback of the song is out of synchronization between the host client computing device and the guest client computing device;
momentarily pausing playing of the song on one of the host client computing device or the guest client computing device to re-synchronize playback of the song;
receiving a feedback message from one of the host client computing device or the guest client computing device;
transmitting the feedback message for display to the other of the host client computing device and the guest client computing device;
storing a portion of the feedback message in a database in association with at least one of the guest user or the host user;
queuing the at least one selected song for playback during the private music session, queuing additional songs for playback during the private music session, and presenting an indication of the queued at least one song and the additional songs to at least the host user for selective playing; and
establishing the private music session between one or more additional guest users, and playing the at least one selected song client computing devices of the one or more additional guest users at the same time that the at least one selected song is being played on the host client computing device.

While the aspects of the disclosure have been described in terms of various examples with their associated operations, a person skilled in the art would appreciate that a combination of operations from any number of different examples is also within scope of the aspects of the disclosure.

### Exemplary Operating Environment

Although described in connection with an exemplary computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like in a modulated data signal such as a carrier wave or other transport mechanism and include any information delivery media.

The examples illustrated and described herein, as well as examples not specifically described herein but within the scope of aspects of the disclosure, constitute exemplary means for establishing a private music session between two client devices in which music is played simultaneously on the devices and one or more devices control the playback of the music. For example, the elements described in FIG. 2, such as when encoded to perform the operations illustrated in FIGS. 4-5, constitute exemplary means for establishing the private music sessions disclosed herein.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A host client computing device operated by a host user for entering a private music session with a guest user and playing music on a guest client computing device, the host client computing device comprising:
memory for storing a music application configured to identify the guest user and request establishment of the private music session with the guest user; and
a processor programmed for:
receiving a request from the host user to establish the private music session with the guest user,
transmitting a music-session request to establish the private music session, wherein the music-session request designates a guest user,
receiving notification that the private music session is established with the guest user,
receiving a selection of music from the host user to play on the client computing device of the guest user,
transmitting an identifier of the selection of music,
receiving an instruction from the host user to play the selection of music, and
transmitting the instruction to control playback of the selection of music on the guest client computing music, wherein the selection of music is played locally and on the guest computing device at the same time.

2. The host client computing device of 1, further comprising:
a second memory, associated with the guest client computing device, for storing a guest music application configured to receive the transmitted instructions to control playback of the selection; and
a second processor associated with the guest computing device, the second set of one or more processors configured for modifying playback of the selection of music on the guest computing device.

3. The host client computing device of claim 1, wherein modification of the playback of the selection of music on the guest computing device comprises at least one member of a group comprising pausing, skipping, fast forwarding, rewinding, or replaying a portion of the selection of music.

4. The host client computing device of claim 1, wherein the identifier of the selection of music comprises at least one of an indication of a song, an artist, or an audio file.

5. The host client computing device of claim 1, wherein the identifier of the selection of music comprises an audio file comprising the selection of music.

6. The host client computing device of claim 1, wherein the processor is further programmed for:
receiving a guest selection of music from the guest user,
playing the second selection of music, and
allowing playback instructions from a guest client computing device being operated by the guest user to control playback of the second selection of music from the guest user.

7. The host client computing device of claim 1, wherein said playing of the selection of music locally involves streaming the selection of music from a web-based music service.

8. The host client computing device of claim 1, wherein the processor is programmed for playing the selection of music locally in synchronization with the music being played on the guest computing device.

9. The host client computing device of claim 1, wherein the processor is further programmed for:
receiving guest playback instructions of the guest computing device; and
modifying said local playing of the selection of music based on the guest playback instructions.

10. The host client computing device of claim 1, wherein the processor is further programmed for:
receiving feedback input from the guest user regarding the selection of music being played;
generating one or more feedback messages to send to the guest user based on the feedback input; and
transmitting the one or more feedback messages for presentation to the guest user.

11. The host client computing device of claim 10, wherein the one or more feedback messages comprise at least one member of a group comprising: a text message, an animation, a thumbs up indication, a thumbs down indication, a video, or a voice indication.

12. The host client computing device of claim 1, wherein the memory and the processor are associated with at least one member of a group comprising a smart phone, a mobile tablet, a wearable device, a gaming console, a laptop computer, a desktop computer, a virtual reality device, or a holographic device.

13. A method for establishing a private music session between at least two client computing devices, the method comprising:
receiving a request from a host user operating a host client computing device to establish the private music session with a guest user operating a guest client computing device;
receiving an identifier of a song selected by the host user or the guest user to be played at the same time on the host client computing device and the guest client computing device;
receiving a play indication from the host client computing device or the client computing device;
synchronizing simultaneous playback of the song on both the host client computing device and the guest client computing device; and
monitoring times of play to ensure the song is synchronously played on the host client computing device and the guest client computing device.

14. The method of claim 13, further comprising:
identifying that playback of the song is out of synchronization between the host client computing device and the guest client computing device; and
momentarily pausing playing of the song on one of the host client computing device or the guest client computing device to re-synchronize playback of the song.

15. The method of claim 13, further comprising:
receiving a feedback message from one of the host client computing device or the guest client computing device; and
transmitting the feedback message for display to the other of the host client computing device and the guest client computing device.

16. The method of claim 15, further comprising:
storing a portion of the feedback message in a database in association with at least one of the guest user or the host user.

17. One or more computer-storage memories embodied with machine-executable instructions for establishing a private music session between at least two client computing devices, comprising:
receiving direction from a host user operating a host client computing device to invite a guest user operating a guest client computing device to join the private music session;
retrieving interaction history between the host user and the guest user, the interaction history comprising a set of previously heard songs in a prior private music session and feedback messages between the host user and the guest user during the prior private music session;
selecting, based on the interaction history, at least one song to play in a private music session between the host user and the guest user; and
instructing the host client computing device and the guest client computing device to play the at least one selected song at the same time.

18. The one or more computer-storage memories of claim 17, further comprising:
queuing the at least one selected song for playback during the private music session;
queuing additional songs for playback during the private music session; and
presenting an indication of the queued at least one song and the additional songs to at least the host user for selective playing.

19. The one or more computer-storage memories of claim 18, further comprising:
establishing the private music session between one or more additional guest users; and
playing the at least one selected song client computing devices of the one or more additional guest users at the same time that the at least one selected song is being played on the host client computing device.

20. The one or more computer-storage memories of claim 19, wherein the interaction history comprises at least one of a group comprising:
an indication of a previously played song in a private music session between the guest user and the host user, one or more feedback messages between the guest user and the host user,
one or more indications of interest submitted by the guest user or the host user,
a song skipping instruction, or
a text message transmitted during a private music session.
